(19) United States
(12) Patent Application Publication
(10) Pub. No.: US 2013/0048211 A1
(43) Pub. Date: Feb. 28, 2013

(54) METHOD FOR PROTECTING SURFACES

(71) Applicants: Serge SIRLEREAUX, Worms (DE); Thierry AGARD, Le Touquet (FR)

(72) Inventors: Serge SIRLEREAUX, Worms (DE); Thierry AGARD, Le Touquet (FR)

(73) Assignees: UNIFLOCKAGE S.A.S., Berck-Sur-Mer (FR); RENOLIT SE, Worms (DE)

(21) Appl. No.: 13/662,583

(22) Filed: Oct. 29, 2012

Related U.S. Application Data
(63) Continuation-in-part of application No. PCT/EP2012/000799, filed on Feb. 22, 2011.

(30) Foreign Application Priority Data
Feb. 25, 2011 (DE) 10 2011 012 517.5

(51) Int. Cl. B32B 37/12

(52) U.S. Cl. 156/276

(57) ABSTRACT

The present invention relates to a method for protecting surfaces, especially surfaces that are normally located under water and vehicle surfaces, comprising the steps of providing a deformable, self-adhesive sheet, flocking the sheet with fibres, and attaching the flocked sheet to the surface.

This application is a continuation in part of PCT/EP2012/000799 filed Feb. 22, 2012, claiming priority of DE 10 2011 012 517.5 filed Feb. 25, 2011, the contents of both of which are incorporated herein by reference in their entirety.

The present invention relates to a method for protecting surfaces, especially for protecting surfaces that are normally located under water, in particular under seawater, from fouling.

The fouling of hulls and other surfaces normally arranged underwater by sticking plant and animal organisms, such as algae, bivalvia and balanidae, is a major problem. There are already various proposals for protection from fouling. For example, “Antifouling Produktliste 2010”, Bewuchs-Atlas e.V., first edition, released in 2010, provides an overview.

Such protective measures which do not require any chemical active ingredients, or at least only few chemical active ingredients, are of particular interest. These include coatings containing fibres as described on pages 31/32 of the above publication and in EP 643 657 as well as EP 1 964 620. The process of applying fibres to hulls is complex, however.

Thus, the object still exists to provide effective protection against fouling, which can be applied in a simple and cost effective manner, is effective over a sufficiently long period of time and requires as few active ingredients as possible that are released into the environment, where they may be harmful.

The surface of cars and other vehicles, e.g. motorcycles, scooters, mini-vans, trucks, trains and the like, is exposed to weathering and to dirt, which can deteriorate the surface. Especially anti-freeze and bird droppings are considered harmful even for modern car finish. Further, it is known to decorate or mark vehicles by applying stickers. A full or partial change of colour can be achieved by adhering a sheet to the surface. Besides the decorative effect such a sheet also provides protection to the surface. Protection is the main objective of transparent sheets applied to areas where typically mechanical stress occurs like the running boards and the loading or trunk sill. However, cleaning of such decorative applications or protective sheets is usually more difficult than for the original surface. Thus, also for vehicle surfaces there remains the problem of protecting the surface from deterioration and furthermore the object to allow for individual decoration.

It has surprisingly been found that it is possible to achieve these objects with deformable, self-adhesive sheets with flocking.

The invention thus achieves the above objects with a method for protecting surfaces that are normally located under water from fouling, in which a deformable, self-adhesive sheet is provided, flocked and adhered to the surface.

In a further aspect, the self adhesive sheets are suitable to protect the surface of vehicles while providing an interesting design at the same time. Thus, the present invention also relates to the protection of vehicle surfaces comprising the steps providing a conformable, self-adhesive sheet, flocking it with fibres and adhering it to the surface.

Surprisingly the vehicle surface obtained by the method of the invention eases cleaning, although one would expect that dirt is more difficult to remove from the rough flocked surface and/or adheres more easily to it. But it was found that the flock is cleaned by rain and also slightly wiping over the surface is able to remove dirt adhering to it. The protective effect is enhanced by the fibres, they contribute to filtering UV light and provide additional protection against mechanical impact.

Since the sheet is deformable, it can also be adhered in an accurately fitting manner to curved surfaces, such as hulls and vehicle surfaces. A coating of gaps with adhesive and subsequent flocking on the hull, as in EP 1 964 620, is unnecessary. In contrast to EP 643 657, only one processing step is necessary, in which the sheet is connected to the surface by means the pressure-sensitive adhesive.

Deformable, self-adhesive sheets for protection from fouling and for protecting or decorating vehicle surfaces are known per se. According to the prior art, however, these are provided with the smoothest possible surface so as to prevent the adhesion of the fouling organisms and to ensure low drag resistance.

All sufficiently abrasion-resistant, saltwater-resistant and UV-stable plastics are suitable material for the sheet used according to the invention. Preferred materials for the sheets according to the invention include polyvinyl chloride (PVC), polyurethanes (PUs), butadiene-based and isoprene-based polymers, and polyolefins such as polyethylene (PE) and polypropylene (PP). Polymers based on vinyl monomers, in particular polyvinyl chloride (PVC), are particularly preferred. Films based on PVC and/or ethylene vinyl acetate (EVA) are likewise well suited.

In a manner known per se, the sheet may have additives and added substances, which are used in the normal amounts. For example, plasticisers, stabilisers and, if desired, pigments and/or dyes are contained in the case of PVC sheets. For example, 60 to 70% by weight PVC; 5 to 10% by weight EVA; 15 to 25% by weight polymer plasticiser; 2.0 to 3.0% by weight barium/zinc stabiliser; 5 to 10% by weight modifier and 0.5 to 10% by weight light stabiliser are typical in the case of a suspension PVC (S-PVC). The amount of pigments/dyes depends on the desired colour. It is possible to provide biocide active ingredients in the sheet material.

Within the scope of the present invention, “deformable” means that the sheet has an elongation at break of at least 200%. The 2% module is from 15 to 25 N/15 mm. The tensile strength lies in the range of 25 to 40 N/15 mm. The elongation at break, 2% module and tensile strength are measured in accordance with DIN EN 527 3/2/200. For vehicle surface protection an elongation at break of at least 100% and a tensile strength of at least 15 N/15 mm are sufficient, the higher values necessary for anti-fouling applications being preferred, though.

The sheets according to the invention are produced in a manner known per se, for example on calenders. Multi-layer sheets, which may have two, three or even more layers, are obtained by coextrusion, direct extrusion or lamination. These methods are known to a person skilled in the art.

The sheet is coated with a pressure-sensitive adhesive so that it can be adhered directly to the surface to be protected. In principle, all adhesives that demonstrate sufficient resistance to seawater and good adhesion, both to the sheet and to surfaces made of metal, wood, paint, etc., are especially suitable for antifouling. A pressure-sensitive adhesive based on acrylates is preferably used. In a preferred embodiment, a biocide active ingredient is added to the pressure-sensitive adhesive, for example Cu₂O, an isothiazolinone and/or a pyrithione. For vehicle surface protection the same adhesives are suitable, although usually no biocide is added.

Adhesives and fibres that are suitable for the relatively long contact with water are used for flocking. For example, polyamide fibres and polyester fibres are well-suited fibres for anti-fouling. Copper fibres, silver fibres or fibres containing biocide active ingredients in and/or on the fibre are also advantageous, however. Fibres containing biocide active ingredient are known per se and have been used previously in medicine. In accordance with the invention, fibres with a content and/or a coating containing copper (I) oxide, isothiazolinones, pyrithiones and other biocide, in particular algicide, active ingredients known per se are suitable.

The incorporation of the active ingredient(s) into the fibres prolongs the duration of the effect, since active ingredient lost over the surface by being washed away can diffuse subsequently from inside the fibre. It is also possible to incorporate a first active ingredient into the fibre and to apply another active ingredient as a coating.

For vehicle surface protection the choice of fibres is broader. However, the selected fibres should also withstand a contact with water (rain) and they have to be weather resistant. The exposure to UV is more severe for sheets used to protect and decorate vehicles. The fibres are chosen for tactile, technical and aesthetic purposes. Suitable fibres are cotton fibres, viscose fibres, polyamide fibres, polyester fibres, acrylic fibres etc., particularly acrylic fibres.

In a variant preferred especially for anti-fouling, fibre mixtures are used so as to obtain a fibre web containing both hydrophobic and hydrophilic fibres. In this case, the surface tension (measured in accordance with DIN 53364) should be >50 dyn, preferably >60 dyn, for the hydrophilic fibres and <30 dyn, preferably <20 dyn, for the hydrophobic fibres.

Typical fibre lengths for anti-fouling are from 0.1 to 8 mm, preferably from 0.3 to 5 mm, and more preferably from 0.5 to 3 mm. The fibre strength should lie in the range of 1.5 to 100 dtex, preferably 2 to 50 dtex, for polymer fibres and 5 to 100 dtex for metal fibres. Preferred diameters are from 10 to 100 μm, preferably 30 to 70 μm.

For vehicle surfaces the fibre length can vary from 0.3 mm to 2 mm, and for vehicle wrapping, a length between 0.5 mm and 1 mm is particularly preferred. The fibre size can vary from 0.9 dtex up to 5.6 dtex and preferably is about 2.2 dtex. The fibres can be either “random cut” or preferably “precision cut”.

Flocking for anti-fouling is carried out with fibre densities in the range of 100 to 500 fibres/mm², preferably of 150 to 250 fibres/mm². For vehicle surfaces the density of applied fibres can vary from 30 to 160 g/m² and more preferably from 60 to 120 g/m² and especially preferred from 80 to 100 g/m².

Water resistant, especially seawater-resistant adhesives that are matched to the sheet are selected as an adhesive for anchoring the fibres. For example, plastisols, which are conventional for the production of flocked T-shirts, are suitable for PVC films. A typical formulation comprises PVC, plasticiser, filler and adhesive strength promoter.

In a variant preferred for anti-fouling, a biocide, for example copper I oxide or an isothiazolinone, such as 4,5-dichloro-2-N-octyl-isothiazolin-3-one, is added to the adhesive, in which the fibres are anchored. Mixtures of biocides are also possible.

To produce the sheets used in accordance with the invention for protection, the deformable sheet is first provided with a self-adhesive coating by means of the pressure-sensitive adhesive. The adhesive can be applied e.g. dissolved in a solvent. The pressure-sensitive adhesive is/will be covered preferably by a release liner, for example siliconised paper. The self-adhesive sheet is then coated with the adhesive to anchor the fibres and is then flocked in a manner known per se. The sheet is then normally wound onto rolls, where it is stored.

For application to the surface to be protected, the surface is cleaned, if necessary, so as to remove adhering fouling and/or dirt. The surface should be clean, grease-free and dry. The sheet is placed over the surface and pressed on, where necessary after having been cut to size and/or after detachment of the release liner.

The sheet is preferably stuck down edge-to-edge. Gaps between adjacent sheetstripes can be closed easily and quickly by pieces of sheet cut to size accordingly. A coating with adhesive is not necessary for this purpose, and there is therefore also no risk of gluing, with the adhesive, of the fibres in the flocked sheets already attached. It is also possible to form an edge of the sheet in a narrow strip without fibres and to glue the sheet in an overlapping manner. In a further variant, it is conceivable, once adhered, for the fibres to be removed in a strip bridging the joint and for the joint to be covered by a strip of flocked sheet. In this case, the strip may have the same structure as the sheet, or, for example with use of a biocide, may have a higher concentration thereof or may comprise a biocide.

The sheet according to the invention is particularly suitable for the protection of the parts of ships, offshore plants, buoys, etc. that contact seawater. It is easily applied by means of the pressure-sensitive adhesive and as a result of the deformability. A further advantage is the fact that, if required, the sheet can be separated much more easily from the surface than the conventional coatings for example. The sheet can be detached, where necessary under the effect of heat.

The sheet is further especially suited to protect and decorate the surface of vehicles. The decorative possibilites are plentiful. The fibres can be coloured, whereby colours of the fibres are obtained by normal bath dyed or spun dyed or other dye processes. Preferred are spun dyed fibres which are dyed into their core. There can also be patterns of fibres, wherein the fibres can be applied continuously (full flocking) or partially (selective flocking) on rolls or sheets.

For full flocking the surface is totally covered with fibres which provides a velvet or suede texture. The sheet can also be printed prior to flocking by screen print, offset, numeric, digital, helio etc. to give it a background colour or a motif with one or several colours. A full flocking, preferably with transparent fibres, then provides a soft texture on the printing. With selective flocking motifs either flocked or in reverse are possible. When the sheet is previously printed the flocked motives can be registered or non-registered on the print, on all the width of the roll or the sheets size. Likewise, transparent sheets flocked with transparent fibres allow a print of the vehicle surface to remain visible. It is also possible to combine transparent and opaque areas on the flocked sheet to combine a decorative design of the sheet with a design already present on the vehicle surface.

An over flocking is also possible, meaning that the sheet is fully flocked on the surface and then a second flocking layer is applied on that layer, usually as selective flocking.

The sheet for vehicle wrapping can also be embossed by heat, which marks a motif and/or design on the surface of the flocked film (lace, flowers, logo, textile patterns etc. . . . ).

The flock fibres can also be mixed to obtain a shiny, glitter, metallic, fluorescent and/or phosphorescent aspect. The use of specific fibres, especially trilobal fibres, mixed with conventional fibres allows to obtain a more or less shiny aspect depending on percentage used, which can range from 1 to 100%.

The invention will be explained on the basis of the following examples, although it is not limited to the embodiments described specifically. Unless indicated otherwise and unless otherwise imperatively clear from the context, percentages relate to weight, and where in doubt to the total weight of the mixture.

The invention relates to all combinations of preferred embodiments, unless these are mutually exclusive. The expressions “about” or “approximately” in conjunction with a number means that at least values 10% higher or lower, or values 5% higher or lower, and in any case values 1% higher or lower, are also included.

### EXAMPLE 1

A sheet was produced on a calender. The sheet formulation comprised: 54.7% by weight PVC with a K-value of 80; 8.5% by weight of ethylene vinyl acetate copolymer; 1.8% by weight acrylate modifier; 21.5% by weight polymer plasticiser; 2.5% by weight stabiliser; 1.7% by weight costabiliser; 8.5% by weight titanium dioxide; 0.7% by weight light stabiliser and 0.1% by weight lubricant. This sheet was first coated with a pressure-sensitive adhesive based on acrylates, and the pressure-sensitive adhesive was covered by a siliconised paper. To anchor the fibres, a plastisol formed from 100 parts PVC (SolVin NA), 52 parts DIDP and 40 parts CaCO₃, which contained 7% isocyanate-containing adhesive strength promoter, was then applied. 20 parts of the filler CaCO₃ were replaced in part in the plastisol by copper (I) oxide, mixed with about 1% of the Cu₂O amount of isothiazolinone or pyrithione. The sheet was flocked in a manner known per se with the fibres listed in Table 1.

TABLE 1

| No. | Fibre material | Length | Strength | Biocide |
|---|---|---|---|---|
| 1 | polyester/polyamide | 1 mm | 3.3 dtex | ./. |
| 2 | polyamide, black | 2 mm | 22 dtex | ./. |
| 3 | polyamide, natural | 2 mm | 22 dtex | ./. |
| 4 | polyamide | 1 mm | 6.7 dtex | ./. |
| | + silver | 1 mm | 6.7 dtex | |
| 5 | polyamide | 1 mm | 6.7 dtex | ./. |
| 6 | polyamide | 2 mm | 40 dtex | |
| | + copper | 1 mm | 100 dtex | |
| 7 | polyester/polyamide | 1 mm | 3.3 dtex | Cu₂O + DCOIT* in |
| | | | | the adhesive |
| 8 | polyamide, natural | 2 mm | 22 dtex | Cu₂O + DCOIT* in |
| | | | | the adhesive |
| 9 | polyamide, natural | 2 mm | 22 dtex | Cu2O + Cu-pyrithi- |
| | | | | one in the adhesive |
| 10 | polyamide, natural | 2 mm | 22 dtex | Cu2O + Zn-pyrithi- |
| | | | | one in the adhesive |
| 11 | polyester | 0.5 mm | 4.6 dtex | Biocide active |
| | + polyester | 1 mm | 4.6 dtex | ingredient in the |
| | | | | fibre |
| 12 | polyester | 0.8 mm | 2.2 dtex | Biocide active |
| | | | | ingredient in the |
| | | | | fibre |

*4,5-dichloro-2-N-octyl-isothiazolin-3-one

The sheets can be attached easily to a hull.

### EXAMPLE 2

Sheets nos 1, 4, 5, 9, 10 and 11 were adhered to metal tablets and the antifouling effect was examined. The tablets were fastened at the circumference of rotatable discs for this purpose and the discs were placed in the sea in Southeast India. The discs were turned either continuously, or were alternately turned for a month and then not turned for a month for the purposes of the examination. During the rotation, a speed of the water flowing past of 20 knots (about 38/hour) was given for the tablets from the speed of rotation and the circumference of the discs. Once a month, the tablets were lifted from the water with the discs and the surface was examined for fouling. A photo was taken, the number of balanidae was counted, and fouling by algae as well as other marine life was protocoled. The discs were then placed back in the sea until the next examination. The results are also provided in Table 2.

TABLE 2

| | Fouling after | | | | | | |
|---|---|---|---|---|---|---|---|
| Surface fibres: | | 1 month | 2 months | 3 months | 4 months | 5 months | 6 months |
| PET/PA, | dynamic | none | algae | none | none | none | none |
| 3.3 dtex, 1 mm long | alternating | none | none | none | none | none | none |
| PA, 6.7 dtex, 1 mm long with | alternating | few algae | few algae | few algae | few algae | ./. | ./. |
| silver | | | | | | | |
| PA, 6.7 dtex, 1 mm long | alternating | none | none | none | none | ./. | ./. |
| PA, 22 dtex, 2 mm long, with | dynamic | none | none | none | few algae | algae | algae |
| 30% Cu₂O and 3% CuPT in | | | | | | | |
| the adhesive | | | | | | | |
| PA, 22 dtex, 2 mm long, with | dynamic | none | none | none | none | few algae | algae |
| 30% Cu₂O and 3% ZnPT in | | | | | | | |
| the adhesive | alternating | none | none | none | none | none | none |
| PET with biocide, 4.6 dtex, | alternating | none | none | none | none | none | ./. |
| 0.5 and 1 mm long (1:1) | | | | | | | |

In some cases (films 4, 9 and 10), few algae were found, whereas a slightly heavier fouling with algae was found in four cases (sheets 9 and 10). Balanidae did not adhere in any case, although they were encountered at the edges of the tablets, said edges not being protected by the sheet according to the invention, within a short period of time in each case, generally after 3 months, but sometimes also after just one month.

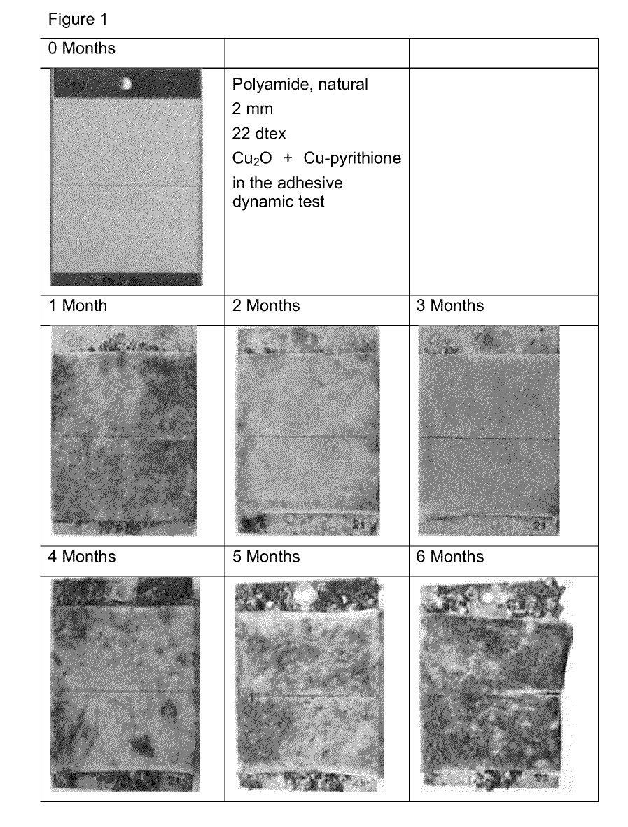

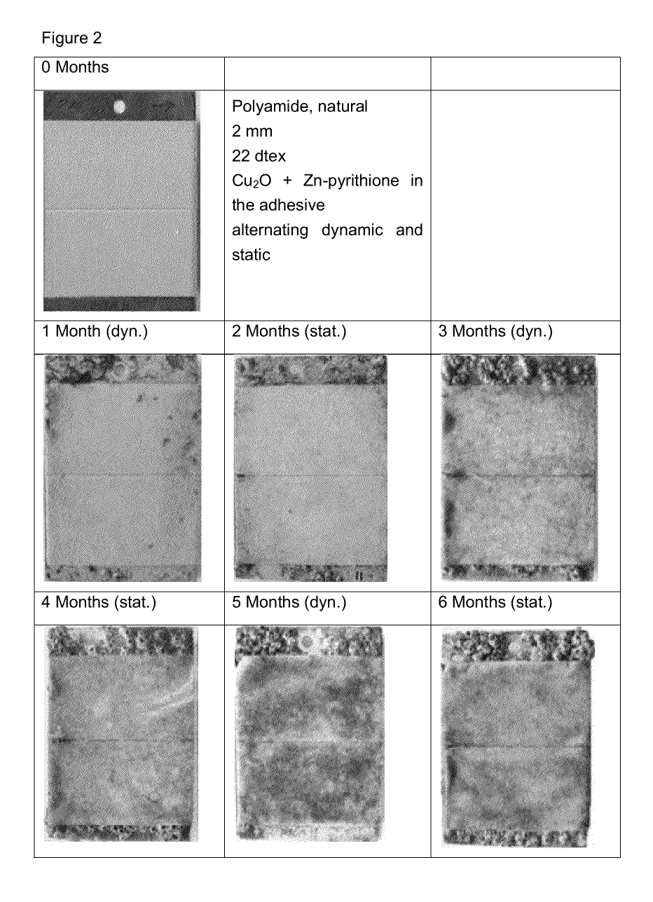

The photos for sheets 9 (dynamic) and 10 (alternating) are shown in FIGS. 1 and 2.

### EXAMPLE 3

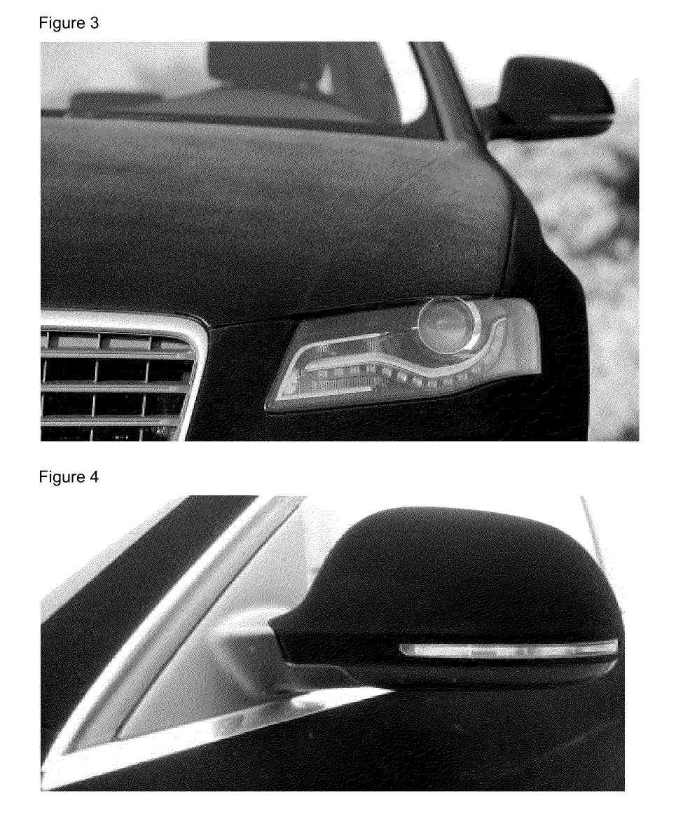

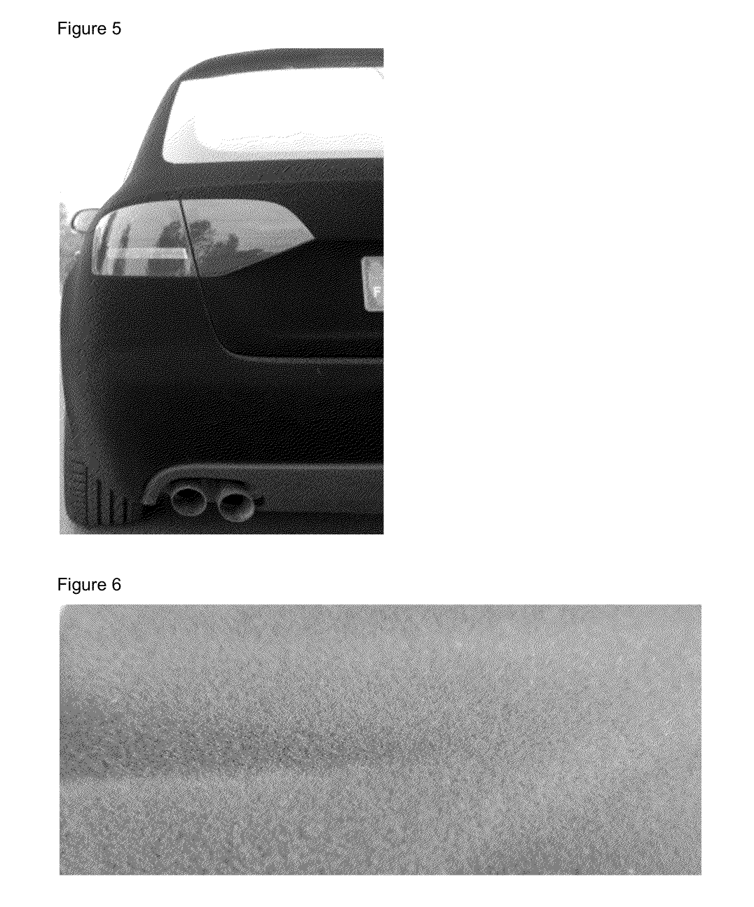

A variety of car surfaces protected and/or decorated according to the invention and sheets for this are shown in the attached FIGS. 3 to 13.

FIGS. 3 to 5 show details of a car with a surface protected by a flocked sheet according to the invention. It can be seen that the sheet smoothly adheres to the surface, also at contours and edges.

FIG. 6 shows a uni coloured sheet and flock providing a velvet look and feel.

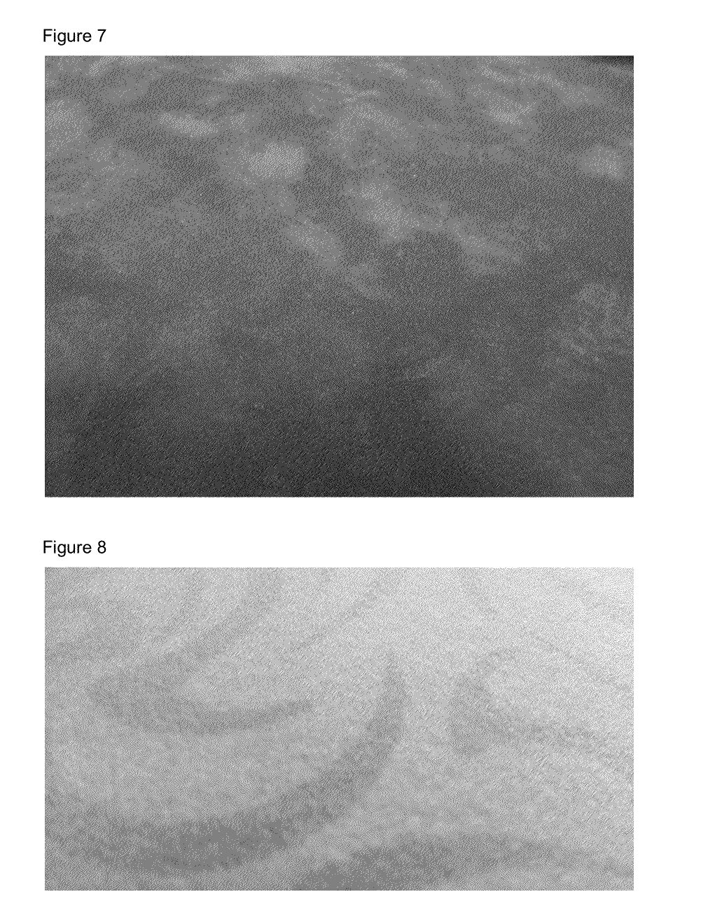

FIG. 7 shows a suede look obtained by a mechanical movement of objects coming on the surface of the flocked sheet before the polymerization to give a non uniform look of velvet.

FIG. 8 shows a printed sheet with transparent flock. The print can be seen through the flock.

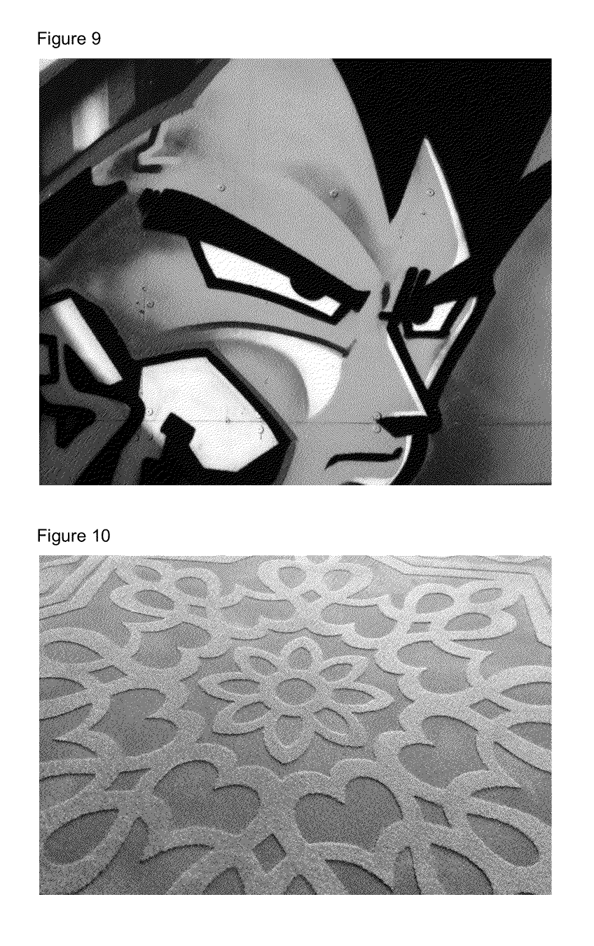

FIG. 9 shows a selective flocking (black parts).

FIG. 10 shows a full flocking with a selective flocking with differently coloured fibres on top.

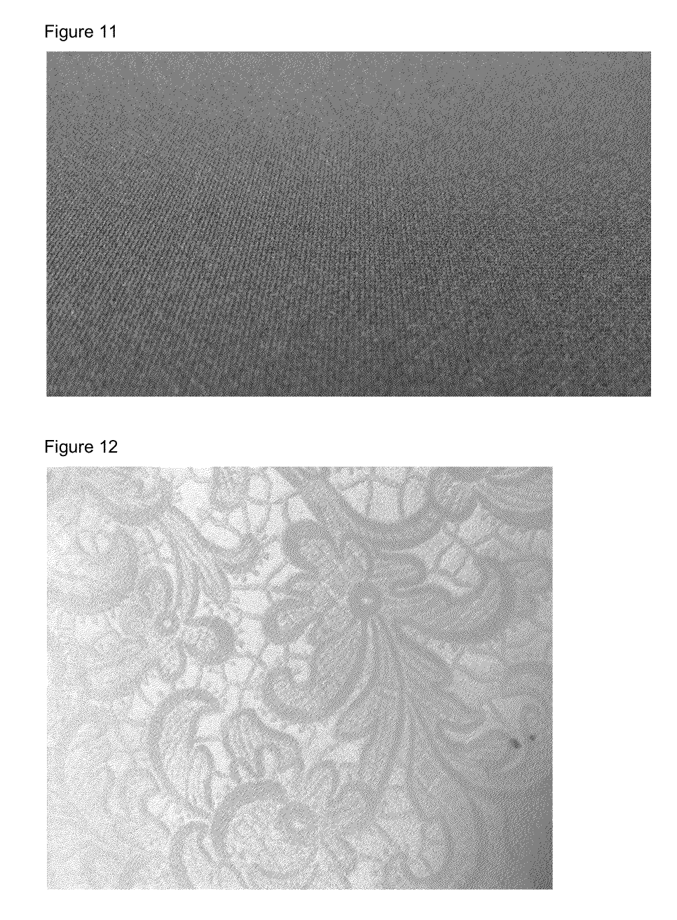

FIGS. 11 and 12 show embossed flocking, that provides yet another interesting design.

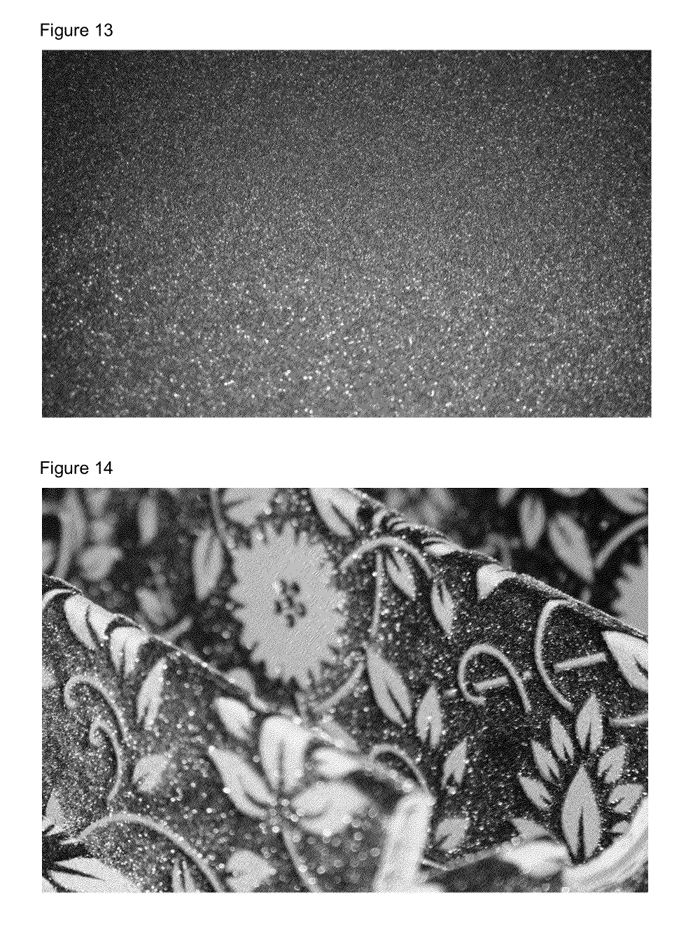

FIG. 13 shows a flocking with 30% of trilobal fibres providing a glitter or metallic design.

FIG. 14 shows another selective flocking on a printed sheet.

The patent or application file contains at least one drawing executed in color. Copies of this patent or patent application publication with color drawing(s) will be provided by the Office upon request and payment of the necessary fee.

1. Method for protecting surfaces comprising the steps of
providing a deformable, self-adhesive sheet
flocking the sheet with fibres
attaching the flocked sheet to the surface.

2. The method according to claim 1, characterised in that the surface is normally under water, and is especially a hull that is protected from fouling.

3. The method according to claim 2, characterised in that the fibres are provided with one or more biocide(s).

4. The method according to claim 2, characterised in that an adhesive used for flocking is provided with one or more biocide(s).

5. The method according to claim 2, characterised in that a pressure-sensitive adhesive, which makes the sheet self-adhesive, is provided with one or more biocide(s).

6. The method according to claim 2, characterised in that the sheet is provided with one or more biocide(s).

7. The method according to one of claims 3 to 6, characterised in that the biocide is selected from copper (I) oxide, isothiazolinones, pyrithiones and mixtures thereof.

8. The method according to claim 2, characterised in that polyamide fibres, polyester fibres, silver fibres or copper fibres or mixtures thereof are used as fibres.

9. The method according to claim 2, characterised in that fibre mixtures are used so as to obtain a fibre web containing both hydrophobic and hydrophilic fibres, wherein the surface tension (measured in accordance with DIN 53364) is >50 dyn for the hydrophilic fibres and <30 dyn for the hydrophobic fibres.

10. The method according to claim 2, characterised in that fibres with lengths from 0.1 to 8 mm, preferably from 0.3 to 5 mm, and more preferably from 0.5 to 3 mm are selected.

11. The method according to claim 2, characterised in that fibres with diameters from 10 to 100 μm, preferably 30 to 70 μm, are selected.

12. The method according to claim 2, characterised in that flocking is carried out with fibre densities in the range of 100 to 500 fibres/mm².

13. The method according to claim 1, characterised in that the sheet is glued edge-to-edge.

14. The method according to claim 13, characterised in that the fibres are removed or are not applied in the region of the joint, and the joint is masked by a strip.

15. The method according to claim 1, characterised in that the sheet is formed with a fibre-free edge region and is glued in an overlapping manner.

16. Method according to claim 1, wherein the surface is a vehicle surface.

17. Method according to claim 15 wherein the surface is the surface of a car, motorcycle, mini-van, truck, bus, or train, especially a car surface.

18. Method according to claim 15 wherein the fibre length ranges from 0.3 mm to 2 mm, preferably from 0.5 mm to 1 mm.

19. Method according to claim 16 wherein the fibre length ranges from 0.3 mm to 2 mm, preferably from 0.5 mm to 1 mm.

20. Method according to claim 15 wherein the fibre size ranges from 0.9 dtex to 5.6 dtex and preferably is about 2.2 dtex.

21. Method according to claim 16 wherein the fibre size ranges from 0.9 dtex to 5.6 dtex and preferably is about 2.2 dtex.

22. Method according to claim 17 wherein the fibre size ranges from 0.9 dtex to 5.6 dtex and preferably is about 2.2 dtex.

23. Method according to claim 15 wherein the density of applied fibres can vary from 30 to 160 g/m² and more specifically from 60 to 120 g/m² and especially preferred from 80 to 100 g/m².

24. Method according to claim 16 wherein the density of applied fibres can vary from 30 to 160 g/m² and more specifically from 60 to 120 g/m² and especially preferred from 80 to 100 g/m².

25. Method according to claim 17 wherein the density of applied fibres can vary from 30 to 160 g/m² and more specifically from 60 to 120 g/m² and especially preferred from 80 to 100 g/m².

26. Method according to claim 19 wherein the density of applied fibres can vary from 30 to 160 g/m² and more specifically from 60 to 120 g/m² and especially preferred from 80 to 100 g/m².

27. Method according to claim 15 wherein the sheet has an elongation at break of at least 100% and a tensile strength of at least 15 N/15 mm.

28. Method according to claim 16 wherein the sheet has an elongation at break of at least 100% and a tensile strength of at least 15 N/15 mm.

29. Method according to claim 17 wherein the sheet has an elongation at break of at least 100% and a tensile strength of at least 15 N/15 mm.

30. Method according to claim 19 wherein the sheet has an elongation at break of at least 100% and a tensile strength of at least 15 N/15 mm.

31. Method according to claim 22 wherein the sheet has an elongation at break of at least 100% and a tensile strength of at least 15 N/15 mm.
